(19) United States
(12) Patent Application Publication
(10) Pub. No.: US 2014/0004336 A1
(43) Pub. Date: Jan. 2, 2014

(54) POLYOLEFIN LAMINATE FILM FOR CARDBOARD LAMINATION

(71) Applicants: Shichen DOU, Warwick, RI (US); Scott NARKEVICIUS, South Kingstown, RI (US); John J. FITCH, Middletown, RI (US)

(72) Inventors: Shichen DOU, Warwick, RI (US); Scott NARKEVICIUS, South Kingstown, RI (US); John J. FITCH, Middletown, RI (US)

(73) Assignee: TORAY PLASTICS (AMERICA), INC., N. Kingstown, RI (US)

(21) Appl. No.: 13/535,233

(22) Filed: Jun. 27, 2012

(51) Int. Cl. B32B 27/10; B32B 27/14; B32B 5/16; B32B 37/12; B32B 27/32; B32B 27/36; B32B 27/28; B32B 37/24; B32B 27/08; B32B 27/30

(52) U.S. Cl. 428/327; 428/516; 428/447; 428/448; 428/323; 428/421; 428/483; 156/244.11

(57) ABSTRACT

Described are polyolefin laminate films including a core layer, a first outer layer on one side including a blend of 5-20 wt % modified polar polyolefin, 5-20 wt % ethylene-propylene copolymer and 80-90 wt % mini-random polypropylene, and an optional second outer layer on the other side of said core layer opposite the first outer layer, including mini-random polypropylene or copolymers or combinations thereof. The laminate film is suitable for hot melt adhesive lamination with paper or cardboard to package a product.

### FIELD OF THE INVENTION

The present invention relates to a laminate film used in paper or cardboard lamination. More specifically, it relates to a laminate that possess good film bond strength with paper or cardboard, low surface coefficient of friction, high gloss, low haze, and/or good moisture barrier properties.

### BACKGROUND OF THE INVENTION

The major ingredient in paper is cellulose, a long chain polar polysaccharide with mixed lignans and phenolics; however, the overall chemistry of paper also depends on the chemical treatments applied to the paper. A conventional discharge-treated laminate film—for instance, multilayered Biaxially-Oriented Polypropylene (BOPP) film—exhibits poor adhesion to paper or cardboard in lamination even if a hot melt adhesive is applied to the lamination. Polar hot melt adhesives show good adhesion to paper or cardboard, but have poor adhesion to a laminate BOPP film. Accordingly, a polar material layer can be used as a tie layer on one side of a laminate BOPP film to provide the adhesion to polar hot melt adhesives. The tie layer can possess desirable bond strength between the hot melt adhesive and a laminate BOPP film for a specific application. The polar materials used in the tie layer can be chemically modified polar polyolefins, which have good compatibility to the polyolefins used in the tie layer or core layer of the laminate BOPP film.

Modified polar polyolefins are made through grafting polar comonomers such as maleic anhydride onto polyolefins or copolymerizing olefins with minor polar co-monomers such as maleic anhydride and unsaturated carboxylic acid or esters thereof (e.g. methyl methacrylate, and butyl acrylate, etc.). In the grafting approach, polar co-monomers are chemically connected to a polymer backbone by grafting without changing the backbone structure of the polymer. In the copolymerizing approach, polar co-monomers are inserted between olefin monomers wherein the polar co-monomers are part of the polymer backbone. Modified polar polyolefins made through the two approaches have found broad applications as compatibilizers between polar polymers and polyolefins. For example, the teachings of maleated polypropylene in U.S. Pat. No. 5,153,074 and ethylene co-butyl acrylate-co-maleic anhydride terpolymer in U.S. Pat. No. 7,695,822 describe approaches of utilizing modified polar polymers as tie layers to improve the overall bonds of EVOH or PVOH to BOPP films.

U.S. Pat. No. 5,153,074 describes a substrate resin composition of a biaxially oriented polypropylene film, including maleic anhydride modified polyolefins (homopolymer or copolymer) coextruded to form at least one skin layer. The laminate film made with addition of maleic anhydride modified polyolefin is hazy and not aesthetically attractive. The polar skin layer cannot be separated directly from the core layer including propylene homopolymer and contain sufficient polar functional anhydride groups to aggressively bond materials such as PVOH and EVOH (used for gas barrier properties). The gas barrier layer is oriented and subsequently corona-treated before metal deposition. The maleic anhydride modified polymers act as an adhesion promoter to achieve adequate adhesion between the polar barrier layer and the non-polar polypropylene substrate.

U.S. Pat. No. 7,695,822 describes a coextruded multilayer polymeric film structure including a layer of a blend of 50-95 wt % (wt % is defined as by weight percentage) EP copolymer and 5-50 wt % ethylene polar terpolymer as a tie layer for a coating of EVOH or PVOH or mixtures thereof. The polar tie-layer material is used to promote adhesion between the polar coating and the non-polar polyolefin substrate. The tie layer has strong bond strength to both the polar coating and polyolefin substrate after orientation. The tie layer materials are selected from ethylene based polar terpolymers and EP copolymers, which are soft and hazy so that the appearance of the laminate film may not be desirable without a primer coat for applications required high clarity and gloss.

U.S. Pat. No. 7,854,987 describes a polymeric film structure for extrusion coating or thermal lamination. A skin layer of LLDPE is coextruded onto the core layer of polypropylene during the manufacturing of BOPP film. LLDPE skin layer of BOPP film provides adequate bonding with ethylene vinyl acetate (EVA) or polyethylene used in thermal lamination wherein tie-layer materials LLDPE is employed as adhesion promoter.

U.S. patent application Ser. No. 11/0268,966 describes multilayered thermoplastic film structures with at least one outer layer including a polyolefin resin with a melting point of 90 to 105° C. The disclosed film structure is suitable for thermal lamination onto substrates such as paper or cardboard. The adhesion-promoter is the polyolefin layer with a melting point of 90 to 105° C. This approach could generate processing problems of sticking onto chill rolls or stretch rolls during manufacturing of the multilayer film on a high speed BOPP film line and is limited to a blown film process. In addition, the thickness of the adhesion-promoting layer is constrained to a minimum of 3 μm which could result in the use of a significant amount of anti-blocking agents or slip agents to achieve acceptable coefficient of friction for film handling and winding. The optical properties of the film are therefore not attractive to the applications of requiring low haze and high gloss.

### SUMMARY OF THE INVENTION

Described are laminate film structures for hot melt adhesive lamination, particularly for boxboard applications. The laminate film structures demonstrate strong bond strengths to paper or cardboard and maintain a high gloss as well as low COF, therefore avoiding processing issues resulting from the lamination.

One embodiment is a laminate film, having high lamination bond strength with paper or cardboard, low surface COF, high gloss, low haze, and good moisture barrier. The laminate may include a core layer including primarily of propylene homopolymer and optional modifiers, and two outer layers. The two outer layers, with a thickness preferably not more than 2 μm respectively, are contiguously attached upon each side of the core layer. The core layer of the laminate film is preferably the thickest layer which provides the foundation of the multilayered laminate structure. The thickness of the core layer preferably is in the range of from 5 to 50 μm, more preferably in the range of from 10 to 20 μm.

The core layer may include polymers selected from isotactic propylene homopolymers and/or mini-random isotactic polypropylenes (for example Total 3270, Total 3271, and ExxonMobil 4772), and optional modifiers such as EP copolymers (for example, Total 8437 and ExxonMobil Vistamaxx 3890FL) and hydrocarbon resins. The content of polypropylene in the core layer is preferably not less than 80 wt % to achieve better processing performance and tensile properties such as modulus and stiffness, and the total content of modifiers in the core layer is preferably not more than 20 wt %. The modifiers incorporated into the core layer have a potential to improve lamination bond strength between the laminate film and hot melt adhesives.

In one embodiment, a hydrogenated hydrocarbon resin may be incorporated into the core layer to improve the processability and moisture barrier of the film. Suitable hydrocarbon resins include but are not limited to petroleum resins, terpene resins, styrene resins and cyclopentadiene resins. The resins may have average molecular weights less than 2000 g/mol and a softening point in the range of from about 95 to 150° C. Suitable hydrocarbon resins, for example, are those such as Plastolyn® R1140 supplied by Eastman Chemical, OPPERA® PR100A supplied by ExxonMobil and Arkon® P-125 supplied by Arakawa Chemical (USA) Inc. The content of the hydrocarbon resin in the core layer is preferably less than 20 wt %, more preferably in the range of from 3 wt % to 15 wt %, based on the total weight content in the core layer.

The first outer layer is a tie layer which can be applied to hot melt adhesive lamination applications, and includes a blend of modified polar polyolefins, EP copolymers, and mini-random polypropylene. The tie layer consists of at least 5 wt % of modified polar polyolefins including maleic anhydride grafted polyolefins or olefin copolymerized polar polymers.

The modified polar polyolefins utilized in the first outer layer may include maleic anhydride grafted polyolefins wherein the amount of grafting may be at most 1.0 wt %. Preferably, the amount of grafting is in the range of from 0.4 wt % to 0.8 wt % for providing effective bond strength to polar substrates such as cardboard or paperboard. Grafting higher than 1.0 wt % may result in undesirable degradation of the polyolefin.

The olefin copolymerized polar polymers harnessed in the first outer layer can be copolymers or terpolymers therefore including at least one olefin monomer and one polar monomer. The olefin monomer can be selected from monomers of ethylene, propylene, and butylene, preferably, ethylene monomer. The polar co-monomers can be selected from unsaturated carboxylic acid or esters thereof and an unsaturated carboxylic anhydride, preferably, maleic anhydride.

Preferably, ethylene is selected as one of the building blocks of the copolymerized polar polymer. Ethylene can form well-defined block chain segments in a polymer backbone with least hindrance to form crystalline structure in polymer matrix which is desirable to control the melting point and crystallinity of the polar polymer to have good processability.

Preferably, maleic anhydride monomer as the first co-monomer is selected to form the copolymerized polar polymer. The anhydride functional group is very active in terms of chemical reactivity and forming strong hydrogen bonding structure between molecules or chain segments.

Preferably, an unsaturated carboxylic acid or esters thereof is selected as the second polar monomer to form the copolymerized polar polymer. The second polar monomer has a moderate polarity and can be used to adjust the structure and polarity of the polar polymer for specific physical properties.

Furthermore, the tie layer includes anti-blocking additives possessing effects of lowering the coefficient of friction (COF) and avoiding film-blocking. The anti-blocking agents can be selected from both inorganic and organic materials. The inorganic materials group includes but is not limited to amorphous silicas, SiO2, CaCO3, aluminosilicates, and sodium calcium aluminum silicates. The organic materials group includes, but is not limited to, ultra high molecular weight polydimethylsiloxane (silicone gum), thermal plastics with high glass transition temperatures; for example, polymethylmethacrylate (PMMA) and cyclic olefin copolymers (COC), and cross-linked silicone polymers.

Preferably, the additives are selected from organic cross-linked micro-fine silicone polymers such as available from Momentive Performance Materials' Tospearl® 120, Tospearl® 130, and Tospearl® 145, and inorganic synthetic amorphous silicas such as available from Mizusawa industrial Chemical's Silton® JC20, Silton® JC-30 and Grace Davison's Sylobloc® 45. The beneficial effects of utilizing these materials as anti-blocking agents include their stability in chemistry and physical shape under processing conditions as well as extremely low residual content.

The optional second outer layer may include mini-random polypropylene and EP copolymers or blends thereof. Suitable mini-random polypropylene resins for the second outer layer are ExxonMobil PP4712 and Total 3375HA (aka EOD0437). (“Mini-random” polypropylenes are a subtype of EP copolymer wherein the ethylene content is less than 1.0 wt % of the polymer, typically 0.3-0.8 wt %. At this fractional ethylene content, such “mini-random” copolymers are crystalline, isotactic polypropylenes, and function suitably and often interchangeably with true propylene homopolymers.) Suitable EP copolymers are Total 8473, Dow Versify 3000 and Vistamaxx 3980FL (these EP copolymers have ethylene content in excess of 1.0 wt % of the polymer, typically from 4.0-20 wt %). The second outer layer can be designed for printing, metal coating, and lamination.

The first outer layer containing polar polymer may be a corona, plasma, or flame discharge-treated layer, preferably a corona discharge-treated surface formed in a controlled atmosphere of CO₂ and/or N₂, to the exclusion of O₂. The surface polarity is greatly increased after the discharge-treatment. Ideally, the second outer layer containing non-polar polymer is also discharge-treated to increase surface tension for lamination or further receiving inks or a vacuum-deposited metal coating on the treated polymer surface.

The laminate film may be made, for example, in a standard sequential biaxially oriented polypropylene film line. The film may be coextruded, cast, and then oriented in both machine direction and transverse direction at optimal processing temperatures and stretch ratios. The advantages of the film may include low production cost, good lamination performance to boxboard materials, and environmental benefits of avoiding a primer coat.

An embodiment of a laminate film structure may include a core layer including at least 50 wt % polyolefin, a first outer layer including a blend of a modified polar polyolefin and ethylene-propylene copolymer or mini-random polypropylene; a cardboard or paper layer; and a hot melt adhesive layer to adhere the first outer layer to the cardboard or paper layer.

The laminate film structure may also include a second outer layer, including for example, mini-random polypropylene and ethylene-propylene copolymer. The second layer may include mini-random polypropylene resins and ethylene-propylene copolymers described with respect to the first outer layer.

The modified polar polyolefin of the first outer layer may be maleic anhydride grafted polyolefins and/or ethylene copolymerized polar polymer. The first outer layer may include modified polar polyolefin, ethylene-propylene copolymer, and mini-random polypropylene. The first outer layer may include an ethylene-propylene copolymer with an ethylene content of from of 0.5 wt % to 15 wt %. The first outer layer may include a mini-random polypropylene with an ethylene content of 1.0 wt % or less, preferably 0.6 wt % to 0.8 wt %.

The first outer layer and the second outer layer may each include an anti-blocking agent and a processing aid. The anti-blocking agent may be, for example, selected from silicas, SiO₂, CaO₃, sodium calcium aluminosilicates, cross-linked silicone polymers, cyclic olefin copolymer, polymethylmethacrylate (PMMA) spheres, and ultra-high molecular weight polydimethyl siloxane (PDMS). The anti-blocking agent may include 0.03 wt % to 5 wt % of the first outer layer and may have a mean particle size of 2 to 6 μm. The processing aid may be, for example, a fluoropolymer. The active content of processing aid may be less than 1000 ppm.

The core layer may include 80 wt % to 100 wt % propylene homopolymer and 20 wt % or less of a modifier. Preferably, the core layer comprises a hydrocarbon resin, a copolymer or a terpolymer modifier. The first outer layer may be discharged treated.

Another embodiment of a laminate film structure may include: a core layer including at least 50 wt % polyolefin; a first outer layer comprising maleic anhydride-grafted polyolefins, ethylene copolymerized polar polymers, ethylene-propylene copolymers and mini-random polypropylene; a cardboard or paper layer; and a hot melt adhesive layer to adhere the first outer layer to the cardboard or paper layer.

The first outer layer may include maleic anhydride, for example, 1 wt % to 95 wt % maleic anhydride grafted polyolefins. The first outer layer may include ethylene copolymerized polar polymers, for example 1 wt % to 20 wt % ethylene copolymerized polar polymers. The first outer layer may include 5 wt % to 30 wt % ethylene-propylene copolymers. The first outer layer may include 1 wt % to 85 wt % mini-random polypropylene.

The maleic anhydride-grafted polyolefins may be homopolymers, copolymers and terpolymers comprising monomers of propylene, ethylene, and butylene. The maleic anhydride-grafted polyolefins may be produced by grafting a maximum of 1.0 wt % of maleic anhydride onto polyolefins.

The ethylene copolymerized polar polymers may be copolymers or terpolymers including ethylene and at least one polar co-monomer. The ethylene content of the ethylene copolymerized polar polymers may be from 80 wt % to 95 wt %, preferably 85 wt % to 95 wt %. The ethylene copolymerized polar polymers may include maleic anhydride, carboxylic acids, esters of maleic anhydride or carboxylic acids. The ethylene copolymerized polar polymers may include maleic anhydride and at least one other polar co-monomer. A total polar co-monomer content in the ethylene copolymerized polar polymers may be, for example, is 5 wt % to 30 wt %.

The first outer layer may include an ethylene-propylene copolymer with an ethylene content of from of 0.5 wt % to 15 wt %. The first outer layer may include a mini-random polypropylene with an ethylene content of 1.0 wt % or less, preferably 0.6 wt % to 0.8 wt %. The first out layer may include an anti-blocking agent and a processing aid.

An embodiment of a method of making a laminate film structure may include co-extruding a film comprising a core layer comprises at least 50 wt % polyolefin and a first outer layer comprising a blend of a modified polar polyolefin and ethylene-propylene copolymer or mini-random polypropylene, and bonding a cardboard or paper layer to the film using a hot melt adhesive. The film may be biaxially oriented. A second outer layer including a mini-random polypropylene and ethylene-propylene copolymer may be co-extruded with the core layer and the first skin layer.

### BRIEF DESCRIPTION OF THE DRAWINGS

FIG. 1 is a schematic depiction of the structure of a cardboard laminate and depicts how the hot melt adhesive can applied to form a laminated structure and close a cardboard box according to embodiments.

FIG. 2 is a graph showing Haze % for the laminate films of Exam. 2, CExam. 2, Exam. 5, Exam. 7 and Exam. 8 before and after a Sutherland rub test (abrasion resistance test).

### DETAILED DESCRIPTION OF THE INVENTION

Described is a laminate film used in paper or cardboard lamination. The laminate film may include a core layer and two outer layers. The core layer, for example, may primarily include propylene homopolymer. The first outer layer—which is a tie layer—may contain modified polar polyolefins such as anhydride-grafted polyolefins and ethylene copolymerized polar polymers. The second outer layer may include non-polar polymers, typically, mini-random polypropylene, ethylene-propylene (EP) copolymer or combinations thereof, formed on the core layer opposite the first outer layer of the polar polyolefin tie-layer. A blend of tie layer resins described herein was created to achieve comprehensive properties including, for example, good lamination bond, high gloss, low haze, low COF and good moisture barrier. The laminate film may be especially suitable for hot melt adhesive lamination between paper or cardboard and biaxially oriented polypropylene (BOPP) films and can be used for food packaging, book covers, and cardboard boxes due to its great moisture barrier. In addition, the laminate film can be printed to show product information and can provide protection to inks on paper or cardboard.

Hot melt adhesives provide superior performance, compared to traditional water- and solvent-based adhesive lamination. Utilizing hot melt adhesive lamination may also be more cost-effective due to its low energy consumption and high productivity capability. In addition, hot melt adhesives do not create the pollution of toxic organic solvents so these adhesive can be environmentally friendly. Furthermore, the second outer layer can be used for printing or metallizing. A printed or metallized BOPP film can, therefore, be laminated with paper or paperboard using hot melt adhesives.

The described laminate film structure can overcome may of the issues previously associated with laminations for cardboard and paper applications. For example, previously anhydride-grafted polyolefins or copolymerized ethylene polar terpolymers have been used as tie-layer resins for bonding polar EVOH or PVOH polymer coatings or coextruded layers onto non-polar polyolefins (e.g. polypropylene). A subsequent process of metal deposition is then applied to the EVOH or PVOH coating or layer to further improve barrier properties. Gloss and haze of the coated films have no influence on the appearance of final metallized film. The uncoated clear film with a polar surface layer might be suitable for lamination onto cardboard; however, one of the limitations of such a BOPP film is their undesirable optical properties. A clear BOPP film made from previous tie layer resins may be very hazy, compared to conventional BOPP films made without the tie layer resins.

In addition, non-polar polyolefins with a low melting point have been used as a tie layer resin or adhesion promoter for hot melt adhesive lamination. However, LLDPE (in general, melting point of LLDPE is lower than 120° C.) and other polyolefins with low melting points (90-105° C.) as tie layer resins can create sticking problems in BOPP film production, because the side of the tie layer can stick to the chill rolls or MD stretch rolls of a standard BOPP line, making the approach impractical or limited to a blown film line. Besides the processing issues, the outer tie layer of the resultant film may be too soft to resist scuffing forces from the downstream packaging processes such as boxboard lamination and cartoning. The described laminations can be used to overcome some or all of these issues associated with conventional laminations.

Modified polar polyolefins have been intensely used in packaging industries as the tie layer resins for adhering a non-polar resins used for multilayered films or multilayered containers to polar materials such as coatings, adhesives or specific polymers. The mechanism of adhesion provided by a tie layer resin can be chemically understood from the structure of the tie layer resin. The functionality of a tie layer resin used in a multilayered film may be similar to that of a compatibilizer used in a polymer blend of two polymers. Polar functional groups in a tie layer resin provide strong dipole interaction forces, hydrogen bonds or even chemical bonds due to active reaction induced during the process of lamination. Non-polar segments or macromolecules in a tie layer resin having similarity in the molecular structure to a substrate provide strong van der Waals force for adhesion. In addition, to achieve desirable adhesion, good interface mixing between polymers from different layers may be important because it promotes polymer chain entanglements and generates a coexisting thin domain blended with chain segments or polymers from different layers. Selection of tie layer resins or adhesion promoters depends on the molecular structure of a polymer substrate. Both molecular similarity and functionality need to be considered to reach adequate adhesion effect in a specific application.

Modified polar polyolefins are tie layer resins or adhesion promoters typically good for bonding polyolefins with polar polymers such as polyvinylidene chloride (PVDC), EVOH/PVOH coatings, and polyamide (PA). The molecular similarity in tie layer resin is olefin segments which can provide strong adhesion to a polyolefin substrate. The polar functional groups in modified polar polyolefins include, but are not limited to: maleic anhydride, carboxylic acid or esters thereof which provide dipole interaction, hydrogen bonds, and van der Waals forces to polar adhesives or coatings such as PVDC, EVOH or PA. Without the polar tie layer, polar materials (adhesives or coatings) can separate from a polyolefin substrate easily due to poor adhesion between said polar material layer and the polyolefin substrate. A tie-layer may be required to promote adhesion between the polar material layer and the non-polar polyolefin substrate.

Modern cardboard is made up of kraft paper including primarily cellulose and other additives. Cellulose is a mixture of polymers with varied molecular weights but with the generic formula of —(CHOH)ₙ—. In general, paper or cardboard is polar materials with lots of hydroxyl (—OH) groups having polarity similar to that in EVOH or PHOH resin. Cardboard is usually made from three layers of kraft paper with a corrugated layer sandwiched between two flat layers while some cardboard is made just from only one thick layer of kraft paper. Cardboard is strong, rigid and stiff, compared to flexible polyolefin films so it is utilized in packaging to make cost-effective rigid containers for foods and detergents. However, cardboard is easy to lose its physical properties and strengths as it absorbs moisture or water from surrounding environments. Polyolefin films with excellent moisture vapor barrier and/or moisture resistance are usually used as a protective measure laminated to cardboard to avoid the moisture problem. A severe environmental condition for cardboard containers, for instance, could be detergent boxes that are used in kitchen or laundry rooms with high relative humidity.

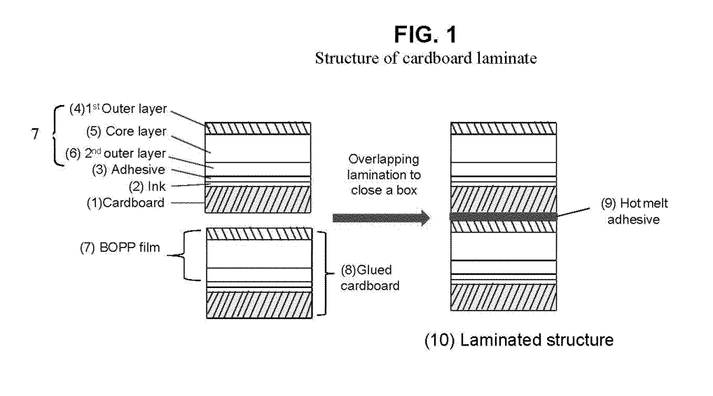

Hot melt adhesive is a thermoplastic, polymer-based adhesive typically applied in the molten state to provide functions of mechanical anchorage at the interface of two layers. In general, hot melt adhesives include building blocks of polymers, tackifiers, plasticizer, wax and antioxidants. Polar polymers such as ethylene vinyl alcohol (EVA), acrylic resins, polyurethanes, ethylene copolymerized polar terpolymers, and blends thereof are usually used in the compositions of a hot melt adhesive applied to polar substrates. The polar hot melt adhesives have good adhesion to kraft paper, EVOH, PVDC, and other polar plastics. HM-2835-Y hot melt adhesive supplied by H.B Fuller was used as an example for lamination between cardboard and a BOPP film. This hot melt adhesive has a melting point of 150° F. (66° C.) and a molten viscosity of 1000 cp at application temperature 350° F. (ca. 177° C.). FIG. 1 depicts how the hot melt adhesive is applied to form a laminated structure and close a cardboard box.

In FIG. 1, production, cardboard (1) is first printed with a UV curable ink (2) to illustrate packaging information and then was laminated with the inventive film (7) using a UV-curable adhesive (3). Multilayer film (7) includes core layer (5), a first outer (tie) layer (4), and a second outer layer (6). Strong lamination bond strength between the second outer layer (6) of the film and cardboard (1) is not required. The second outer layer (6) of the film (7) is placed facing to the surface of the printed cardboard (1). The first outer tie layer (4) becomes the top surface or outermost surface of a glued cardboard laminate (8), which includes film (7), adhered to the cardboard (1) with adhesive (3). A glued cardboard laminate (8) is cut and folded in accordance with box design to make a box by overlapping lamination between two glued cardboard laminates (8) wherein the paper-side of a glued cardboard laminate (8) is adhered with the polymer-side (tie layer (4) of film (7)) of another part of the glued cardboard laminate (8) using a hot melt adhesive (9) at operation temperature 350° F. (ca. 177° C.) and desirable pressure. For the box construction, a hot melt adhesive lamination can be applied for assembling including the side, bottom, and top of a box. After the lamination of the side and bottom of a box, a product can be put into the box and then the box can be closed by hot melt gluing. A key parameter for the box robustness is to have high adhesive strength between the cardboard side (1) of laminate (8), the hot melt adhesive (9) and the polymer side of film (7)'s first outer layer (4).

Conventional laminate OPP films usually have at least one non-polar outer layer for providing heat sealability functionality, and a core layer; the laminate film's ultimate design is based on the requirements of different applications. An optional outer layer can be used to add special functionality such as a coating or printing receiving layer onto the laminate film. Surface treatment may be required to boost the surface tension of the outer layer to achieve good adhesion between the laminate substrate and coatings or inks. In the cardboard lamination as described above, surface treatment alone is not enough to provide strong bond strength to keep a cardboard box closed. In other words, the bond strength between the treated outer layer of a conventional laminate OPP film and the polar hot melt adhesive is often not strong enough due to the difference in polarity between the two materials. The tie layer or adhesion promoting layer described herein can be the outer layer of a laminate film for strong bonding to polar hot melt adhesives. The polar materials in the tie layer preferably have strong bond strength to the hot melt adhesive to avoid separation due to the tension of a physically bent or folded cardboard. Polyolefin films with a polar tie layer can be laminated onto cardboard using hot melt adhesives to achieve desirable lamination bond strength between the polyolefin film and cardboard. Modified polar polyolefins with molecular structure similar to the polypropylene core of a laminate film and with the polarity similar to the hot melt adhesive are ideally suitable for use as the first outer layer resin. The lamination bond strength between the cardboard substrate and the tie layer is preferably not less than 400 g/in, more preferably higher than 500 g/in.

Maleic anhydride monomer can be grafted—for instance, by extrusion process—onto polyolefins such as polypropylene, polyethylene, and ethylene-propylene copolymer to prepare modified polar polyolefins which are suitable for effectively bonding non-polar polypropylene or polyethylene to polar materials such as polar hot melt adhesive or EVOH or other polar polymers or materials. The extent of grafting needs to be controlled at most 1.0 wt %, preferably, 0.4 wt % to 0.8 wt %, to avoid severe degradation of polymer chains induced by the attacks of free radicals resulting from thermal initiators at the elevated temperatures used for grafting. Grafting temperature, initiator content and residence time need to be controlled carefully. In general, 0.4 wt % to 0.8 wt % of maleic anhydride grafting is not suitable for applications required high content of polar components to boost adhesion. Examples of anhydride-grafted polyolefins include Mitsui's Admer® resins and DuPont's Bynel® adhesive resins.

Aside from grafting technology, modified polar polyolefins can also be produced through copolymerization technology. Ethylene polar terpolymers such as Lotader® resins (ethylene-acrylic esters-maleic anhydride) commercially available from Arkema have been successfully used as tie layer resins to bond polyethylene to polar resins like EVA or EVOH. Lotader® 3210 and Lotader® 4503 are two examples of Lotader® resins. Lotader® 3210 (Tₘ=107° C.) is a terpolymer (of ethylene-butyl-acrylate-maleic anhydride) with low co-monomer content, the content of polar co-monomer in the terpolymer is 6.0 wt % for butyl acrylate and 3.1 wt % for maleic anhydride, respectively. Lotader® 4503 (Tₘ=77° C.) is a terpolymer (of ethylene-methyl-acrylate-maleic anhydride) with high co-monomer content, the content of methyl acrylate is 20.0 wt % and the content of maleic anhydride is 0.3 wt %. Another example of ethylene copolymerized polar polymer is DuPont Biomax® 120, which has a structure of ethylene-glycidyl methacrylate and a melting point of 70° C.

High density polyethylene (HDPE) usually cannot effectively bond to high crystalline polypropylene (HCPP) substrate due to the difference in monomer structure between two polymers. Polymer chains of two different high crystalline polymers (for instance HCPP and HDPE) attempt to reorganize their chain segments after the melt mixing during processing to form their own crystals at the interface boundary of a laminate, and therefore the extent of polymer chain entanglements between HDPE and HCPP is reduced due to the crystallization of two polymers. A branched polymer such as linear low density polyethylene (LLDPE) is dynamically easier to mix with another polymer such as homopolypropylene to form chain entanglements at interface (leading to a stronger bond). The hindrance resulted from branches of the LLDPE polymer makes the crystals of LLDPE less perfect (with defects of branches), therefore the crystals melt at a temperature lower than the standard melting point (Tₘ) of a perfect PE crystal such as that in HDPE resin. High co-monomer content in a random copolymer leads to lower Tₘ, lower crystallinity, and higher extent of polymer chain entanglement (better mixing) at the interface boundary. Conversely, low co-monomer content, the Tₘ and crystallinity of ethylene copolymerized polar terpolymer will be higher, and lower bond strength may be expected for lamination bond. The content of co-monomer in ethylene polar terpolymers may be critical for ethylene segments to form effective bond to polypropylene substrate. In principle, higher co-monomer content, leading to lower melting point and lower crystallinity, can provide better bonding strength to polypropylene substrate. However, in extrusion and film orientation, the low melting point of ethylene copolymerized polar terpolymer could result in severe processing issues such as resin pellet bridging in the resin feeding system, sticking to the cast rolls and MDO rolls, etc. The Lotader® resins used alone therefore may not be suitable for the tie layer resin of polypropylene substrate due to poor adhesion at low co-monomer content end and poor processability at high co-monomer content end. A solution to solve the issue is the rule of molecular similarity. The core layer of the OPP film can be modified with ethylene-propylene (EP) copolymer to improve the adhesion between the tie layer and the core layer. At the molecular level, EP copolymer is a compatibilizer to the propylene segments in the core layer and the ethylene segments of Lotader® resins in the tie layer. Therefore, this formulation can solve the issue of compatibility between modified polar polyolefins and the polyolefin in the core layer. With addition of EP copolymer into the BOPP core layer, Lotader® tie resins with low or high polymer co-monomer content can be used as an effective tie-layer as an alternative to anhydride-grafted polyolefins. This blend as tie layer resin can provide effective adhesion to bond polypropylene substrates and polar materials such as EVOH or to hot melt adhesive systems.

The propylene segments of EP copolymer can provide effective bond strength to the core layer of a BOPP film. The blend of Lotader® resins and EP copolymer has not only lower melting point but also lower crystallinity due to the structure of copolymer and terpolymer. The tie layer has lower hardness due to its low crystallinity, compared to the higher crystallinity polypropylene core. Low crystallinity in the tie layer will increase the COF of the surface, so higher loading in antiblocking agents (ABA) or slip agents might be needed for lowering surface COF.

In one embodiment, the laminate film may include: a first mixed tie resin outer layer including anhydride-grafted polypropylene, EP copolymer, and/or ethylene copolymerized polar copolymer or terpolymer with low or high co-monomer content, in which one side of the mixed tie resin outer layer is discharge-treated for further increasing surface energy; an isotactic propylene homopolymer core layer in which one side of the core layer is contiguously attached to the side of the mixed resin tie layer opposite the discharge-treated side; and the opposite side of the core layer is facing or contiguously attached to an optional second outer layer in which the side of the second outer layer opposite the core layer is discharge-treated for suitability for printing or coatings. The second outer layer may include propylene homopolymer, mini-random polypropylene or propylene-based copolymers or mixtures thereof. Additionally, anti-blocking agents (ABA) or slip agents can be incorporated into the mixed tie resin blend first outer layer or the optional second outer layer to avoid film blocking and reduce the coefficient of friction of the tie resin first outer layer (see details below).

The core layer is preferably at least 80 wt % polyolefin. Preferably, the core layer resin may include 80 wt % to 100 wt % semi-crystalline polypropylene with a specific isotacticity and 0 wt to 20 wt % modifiers such as EP copolymers and hydrocarbon resins. In some embodiments, the core layer comprises at least 1 wt % modifiers. The core resin layer is typically 5 μm to 50 μm in thickness after biaxial orientation, preferably between 10 μm and 20 μm. Semi-crystalline polypropylenes generally have an isotacticity ≧90% as can be measured by ¹³C NMR spectra obtained in 1,2,4-trichlorobenzene solutions at 130° C. The % percent isotactic can be obtained by the intensity of the isotactic methyl group at 21.7 ppm versus the total (isotactic and atactic) methyl groups from 22 to 19.4 ppm. Suitable examples of semi-crystalline polypropylenes are Total 3271 and 3270, and ExxonMobil PP4772. Typically, these resins have a melt flow rate of about 0.5 to 5 g/10 min., and the melting point of about 163-167° C. and a density of about 0.90-0.91 g/cm³. Suitable EP copolymers are Dow Versify® 3000, ExxonMobil Vistamaxx® 3980FL and Total 8473. The content of EP copolymer in the core layer is preferably in the range of from 0 wt %-20 wt % of the layer, more preferably, in the range of from 0 wt % to 10 wt %. Suitable hydrocarbon resins are Plastolyn® R1140 supplied by Eastman Chemical, OPPERA® PR100A supplied by ExxonMobil and Arkon® P-125 supplied by Arakawa Chemical (USA) Inc. These hydrocarbon resin grades are typically found as master batches including 50-60 wt % active hydrocarbon resin content of the masterbatch, with the carrier resin of propylene homopolymer. Preferred are hydrocarbon resins based on polydicyclopentadiene. Suitable amounts of active hydrocarbon content in the core layer are from 0 wt % to 10 wt %.

In the embodiment above, the mixed resin first outer layer which is a polar tie layer, includes primarily anhydride-grafted polypropylene which provides polar functionality to bond polar materials and molecular similarity for perfect mixing to polypropylene substrate of the core layer. Preferably, the content of anhydride-grafted polypropylene in the first tie outer layer is in the range of 70 wt % to 95 wt %. EP copolymer is also used in the first outer layer composition to reduce the rigidity of the mixed resin first outer layer while ethylene copolymerized polar copolymer or terpolymer with low or high co-monomer content are herein used for increasing the polar fraction in the tie layer. The mixed resin first outer layer acts as the “tie-layer” to effectively bond a polar polymer layer such as hot melt adhesive or EVOH to the polypropylene core layer. The EP copolymer can be any commercially available EP copolymers with ethylene content from about 0.5 wt % to 15 wt %. Preferably, the ethylene content in the EP copolymer of this tie-layer blend is preferably in the range of 3 wt % to 8 wt % to have good processability. The melt flow rate of EP copolymer is preferably in the range of 2 to 12 g/10 min. measured at conditions of 230° C. and 2.16 kg weight. Examples of suitable resins for this application include Dow Versify® 3000 (with a melt flow rate of 8 g/10 min. and melting point of 108° C.), ExxonMobil Vistamaxx® 3980FL (with ethylene content of 9 wt %) and Total 8473 (with ethylene content of about 4 wt %). Aside from anhydride-grafted polypropylene resin, ethylene copolymerized polar polymers are also incorporated into the mixed tie resin first outer layer for increasing the functionality of polar groups at an amount of 0-10 wt %, preferably 2-10 wt % of the first outer layer. Suitable resins for this application include Lotader® resins, DuPont Bynel® modified EVA series, and DuPont Biomax® resins. Ethylene copolymerized polar terpolymers are commercially available from Arkema, for example, Lotader® 3210 and 4210 (ethylene-butyl acrylate-maleic anhydride terpolymer) or Lotader® 4503 (ethylene-methyl acrylate-maleic anhydride terpolymer). Lotader® 3210 is a copolymer of about 90.9 wt % ethylene, 6 wt % butyl acrylate, and 3.1 wt % maleic anhydride; Lotader® 4210 is about 89.9 wt % ethylene, 6.5 wt % butyl acrylate, and 3.6 wt % maleic anhydride. Lotader® 4503 is a terpolymer with about 79.7 wt % ethylene, 20 wt % methyl acrylate, and 0.3 wt % maleic anhydride. To avoid processing issues in extrusion and orientation processes resulting from the ethylene copolymerized polar polymers, the amount of ethylene monomer is preferably in the range of 80-95 wt % of the terpolymer, more preferably 85-95 wt % of the terpolymer. The ratio of two co-monomers of the terpolymer can be adjusted to achieve different polarity for adhesion Anhydride co-monomer has higher polarity than acrylate ester comonomers.

In another embodiment, the mixed tie resin blend first outer layer includes EP copolymer and ethylene copolymerized polar polymer. Ethylene copolymerized polar polymers are the sole resin materials to provide polar functionality to the mixed tie layer resin blend in this embodiment. There is no anhydride-grafted polypropylene incorporated into the tie layer. EP copolymer resin is the primary component in the tie layer. Propylene segments in EP copolymer offer strong interface bonding strength between the tie layer and the polypropylene core layer of a laminate OPP film. Polar functional groups of ethylene copolymerized polar polymers provide bond adhesion to the polar materials such as polar hot melt adhesives or EVOH. Suitable EP copolymers are Dow Versify® 3000, ExxonMobil Vistamaxx® 3980FL and Total 8473 described previously. The content of EP copolymer in the tie layer is preferably in the range of from 60 wt %-95 wt % of the first outer tie layer, more preferably, in the range of from 70 wt % to 90 wt %. Suitable ethylene copolymerized polar polymers include but are not limited to Lotader® resins, DuPont Bynel® modified EVA series, and DuPont Biomax® resins as described previously. The content of ethylene copolymerized polar polymers in the mixed tie resin blend first outer layer is preferably about 5 wt % to 40 wt % of the layer, more preferred is in the range of from 10 wt % to 30 wt %. The mixed tie-layer resin blend can be coextruded on one side of the core layer having a thickness after biaxial orientation between 0.1 and 5 μm, preferably between 0.5 and 3 μm, and more preferably between 1.0 and 2.0 μm.

In another embodiment, the mixed tie resin blend first outer layer includes EP copolymer, mini-random polypropylene, and ethylene copolymerized polar polymer. Mini-random polypropylene resin in the tie layer is the primary component and offers strong bond strength to the polypropylene core layer due to molecular similarity. Suitable mini-random polypropylene resins include but not limited to ExxonMobil PP4712, Total 3375HA (aka EOD0437), and Conoco Phillips CR027, including ethylene component in the range of less than 1.0 wt %. The melt flow rate of suitable mini-random polypropylenes may be in the range of 2.5 to 5 g/10 min. and the melting point of suitable mini-random polypropylene may be in the range of 155 to 165° C. The content of mini-random polypropylene in the first outer layer may be in the range of from 40 wt % to 90 wt %, more preferably, in the range of 60 wt % to 85 wt %. The EP copolymer resin may be the secondary component in the tie layer and acts as the compatibilizer between mini-random polypropylene and ethylene copolymerized polar polymer. Suitable E-P copolymer resins are Dow Versify® 3000, ExxonMobil Vistamaxx® 3980FL and Total 8473 as described previously. The content of EP copolymer in the tie layer may be preferably in the range of from 0 wt % to 20 wt %, more preferably, in the range of from 7 wt % to 15 wt %. Ethylene copolymerized polar polymer in the tie layer provides polar functional groups to bond the polar materials such as polar hot melt adhesives or EVOH. Suitable ethylene copolymerized polar polymers include but are not limited to Lotader® resins, DuPont Bynel® modified EVA series, and DuPont Biomax® resins as described previously in the art. The content of ethylene copolymerized polar polymers in the mixed tie resin blend first outer layer is preferably about 5 wt % to 20 wt %, more preferably in the range of from 10 wt %-20 wt %.

Optionally, a small amount of processing aids such as a fluoropolymer additive can be incorporated into the first outer layer to effectively avoid any possible die build up due to the polarity of the compositions in the first outer layer. Preferably, the amount of processing aids is less than 1000 ppm in the mixed tie layer resin blend, more preferably, less than 500 ppm.

Anti-blocking agents (ABA) or slip agents are needed to be incorporated into the mixed tie layer resin blend or the optional second outer layer to avoid film blocking and reduce the coefficient of friction of the tie layer. Polymers such as propylene homopolymer and EP copolymer resins are used as the carrier resin to prepare a masterbatch of anti-blocking agents or slip agents for homogeneous distribution of ABA particles in the tie layer. For better COF control effect, preferably, a mixture of different sizes of ABA particles can be used together in an outer layer. ABA materials can be selected from inorganic materials such as silicas, SiO2, CaCO3, sodium calcium aluminosilicates, and organic materials such as cross-linked silicone polymers (polymethylsilsesquioxane, Tospearl® series), cyclic olefin copolymer (COC), polymethylmethacrylate (PMMA) spheres, and ultra high molecular weight polydimethyl siloxane (PDMS). ABA particle sizes are typically in the range from 1-10 μm, more preferably, in the range of 2-6 μm. The loading amount of organic anti-blocking agents is usually higher than that of inorganic ABA due to their lower hardness values. Preferably, the amount of organic ABA may be in the range of from 1000 ppm to 20,000 ppm, more preferably, in the range of 2000 ppm to 10,000 ppm. High ABA loading will make the film product hazier and less attractive unless high haze is the characterization of typically designed for a film product.

COF value may be a desirable characteristic of the laminate. High COF can generate scuffing and scraping on the surface of laminate films during cardboard lamination. The defects of scuffing and scraping will impact the aesthetics of products so that they are not desirable. In principle, lower COF and higher hardness of laminate films help reduce scuffing and scraping if the equipment load (of clamping, pressing and rolling) applied to the laminate is the same. The first outer tie layer of the film is the layer on the top surface after a laminate OPP film is glued to the cardboard; the top surface of the glued laminate receives the equipment load of rolling, clamping, and pressing in the process of cutting, folding and laminating needed for forming and closing a cardboard box. To avoid scuffing and scraping in cardboard lamination, preferably, the static COF of the first outer layer's exposed surface may be less than 0.25 and dynamic COF may be less than 0.22; more preferably, the static COF is less than 0.2 and the dynamic COF is less than 0.18. For the second outer layer which is for printing or coating, the COF of the laminate film is preferably less than 0.5.

The characteristics of high transparency and low haze of a laminate film provides glossy and aesthetic appearance to packaging. High clarity and great aesthetics offer brand building opportunities to a new product. Optical properties of a laminate film can sometimes therefore be very important to innovation and new product development. The compatibility of polymers in each tie layer and at interface between different layers of the laminate impacts the clarity of the laminate OPP film greatly. In addition, the content and loading of anti-blocking agents also contribute to the optical properties of the laminate film. Optical properties of the laminate can benefit from smaller ABA particle size, crystal size, and better compatibility. According to this mechanism, a number of factors need to be balanced in formulation to achieve desirable optical properties of the laminate film. According to the packaging application, the haze may be preferably less than 4.5% and the gloss (60°) is preferably higher than 120 for a single sheet of laminate OPP film.

A process of coextrusion and biaxial orientation was used to make the laminate OPP film. Dry blended resins for different respective layers were extruded through multiple extruders and then into a three-layered compositing die before casting onto a chilling drum with a temperature controlled in the range of 20° C. to 60° C. The core layer of the film was sandwiched between the tie resin first outer layer and the optional winding or printing second outer layer. The cast sheet was stretched about 4 to 6 times in the longitudinal direction at a temperature of 135 to 165° C. and then stretched about 7 to 12 times in transverse direction in the tenter oven with a controlled temperature of 130° C. and 160° C. An annealing/heat-set step was applied to the stretched film before surface treatment. The annealing helps reduce internal stresses resulting from orientation and minimize shrinkage in downstream applications. After corona, plasma, or other discharge-treatment, the film was collected and wound into a roll. The biaxially oriented film had a total thickness between 6 and 30 μm, preferably between 10 and 20 μm, and most preferably between 12 and 18 μm.

In one embodiment, aqueous acrylic or urethane coating was applied to the tie resin first outer layer made with anhydride-grafted polypropylene resin to improve surface optical properties of the tie layer. Both “in-line” and “out-of-line” coating processes work well for this purpose. Preferably, the thickness of the coatings is in the range of from 0.2 μm to 0.5 μm after drying and film orientation. However, the coating process is less cost-effective because it adds cost into the final product.

This invention will be better understood with reference to the following examples, which are intended to illustrate specific embodiments within the overall scope of the invention.

### EXAMPLES

### Example 1

A tri-layer film is made through a process of coextrusion and biaxial stretching in a BOPP film line. The coextruded film included a core layer of a propylene homopolymer and two outer layers. The first outer layer—which is the tie layer for thermal lamination to hot melt adhesive—included a mixture of resins of 92.5 wt % Admer® QF 500A, 7.15 wt % Total 8473, 0.1 wt % Tospearl® 120, and 0.25 wt % Tospearl® 130. The mixed resins were dry-blended before coextrusion (see Table 1). The core layer included 100 wt % Total 3271 polypropylene. The second outer layer on the core layer opposite to the first outer layer included 100 wt % Total 3375HA (aka EOD 0437) which is a mini-random PP copolymer containing 300 ppm of SILTON® JC-30. The total thickness of the finished film was about 70 gauge (0.7 mil or 17.5 μm). About 4 gauge (1 μm) was the thickness for both the first outer layer and second outer layer, respectively. The thickness of the core layer was therefore about 62 gauge (15.5 μm).

The resins of each layer were extruded at a temperature range of 450-480° F. (230 to 260° C.) by an individual extruder for each layer. Polymer melts from each extruder met at a die block and flowed through a tri-layer flat die before casting on a chill drum at a temperature range of 100-180° F. (38 to 82° C.). The thickness of the tri-layer sheet was measured by a scanner, and then the cast sheet was passed through a series of heating rolls with elevated temperatures from 210-270° F. (99 to 132° C.); therefore it was probably stretched in machine direction (MD) at a stretch ratio 5 times. The step of machine direction orientation (MDO) was followed by a transverse direction (TD) stretch in a tenter oven at 310-350° F. (154 to 177° C.) at a stretch ratio 8 times. The clear film was corona-treated upon both sides before wound into a roll. The clear film was measured for lamination bond, COF, hot slip COF, optical properties, MVTR barrier, and “H bond” adhesion strength in accordance with the standard procedures described in the section of Test Methods.

Materials and compositions of the first outer layer (tie layer) are shown in Table 1 for the various Examples. The core resin includes propylene homopolymer resin and the second outer layer resin includes mini-random PP in all Examples.

TABLE 1
Materials and Composition

| | First outer layer materials and composition (wt %) | | | | | | | | |
|---|---|---|---|---|---|---|---|---|---|
| | Admer | Biomax | Lotader | Total | Tospearl | Tospearl | Total | | Dow Corning |
| Example # | QF500A | 120 | 3210 | 8473 | 120 | 130 | 3375HA | JC30 | MB50-801 |
| Exam. 1 | 92.5 | | | 7.15 | 0.1 | 0.25 | | | |
| Exam. 2 | 90 | | 2.5 | 7.15 | 0.1 | 0.25 | | | |
| CExam. 2* | 90 | | 2.5 | 7.15 | 0.1 | 0.25 | | | |
| Exam. 3 | 87.5 | | 5 | 7.15 | 0.1 | 0.25 | | | |
| Exam. 4 | 82.5 | | 10 | 7.15 | 0.1 | 0.25 | | | |
| Exam. 5 | 87.5 | 5 | | 7.15 | 0.1 | 0.25 | | | |
| Exam. 6 | 87.5 | 2 | 3 | 7.15 | 0.1 | 0.25 | | | |
| Exam. 7 | | | 10 | 7.15 | 0.1 | 0.25 | 82.5 | | |
| Exam. 8 | | | 20 | 79.95 | | | | 0.05 | |
| Exam. 9 | | | 10 | 89.95 | | | | 0.05 | |
| Exam. 10 | | | 10 | 89.45 | | | | 0.05 | 0.5 |
| Exam. 11 | | | 10 | 10.55 | | | 78.4 | 0.05 | 1.0 |
| CExam. 1 | | | | | | | 100 | | |

*CExam. 2 also includes over-coating of polyurethane upon first outer layer of which the other Examples do not.

### Example 2

A process similar to Example 1 was repeated except that the mixed resin first outer layer included a blend of 90 wt % Admer® QF500A and 2.5 wt % Lotader® 3210 as well as the same amount of EP copolymer Total 8473 and anti-blocking agents Tospearl® 120 and 130 as in Example 1. The laminate film was measured for lamination bond, COF, hot slip COF, optical properties, MVTR barrier, H bond adhesion strength, and abrasion resistance in accordance with the standard procedures described in the section of Test Methods.

### Comparative Example 2

A process similar to Exam. 1 was repeated except that an aqueous polyurethane coating was coated on the first outer tie layer substrate wherein the first outer tie layer includes the same compositions as in Exam. 2 after machine direction stretch by a well known in-line coating process. The thickness of coating was estimated at about 0.3 μm after drying and orientation. The coated clear film was corona-treated before testing and evaluation. The laminate film was measured for lamination bond, COF, optical properties, MVTR barrier, H bond adhesion strength, and abrasion resistance in accordance with the standard procedures described in the section of Test Methods.

### Example 3

A process similar to Example 1 was repeated except that the mixed resin first outer layer included a blend of 87.5 wt % Admer® QF 500A and 5.0 wt % Lotader® 3210 as well as the same amount of EP copolymer Total 8473 and anti-blocking agents Tospearl® 120 and 130 as in Example 1. The laminate film was measured for lamination bond, COF, optical properties, MVTR barrier, and H bond adhesion strength in accordance with the standard procedures described in the section of Test Methods.

### Example 4

A process similar to Example 1 was repeated except that the mixed resin first outer layer included 82.5 wt % Admer® QF500A and 10.0 wt % Lotader® 3210 as well as the same amount of EP copolymer Total 8473 and anti-blocking agents Tospearl® 120 and 130 in Example 1. The laminate film was measured for lamination bond, COF, optical properties, MVTR barrier, and H bond adhesion strength in accordance with the standard procedures described in the section of Test Methods.

### Example 5

A process similar to Example 1 was repeated except that the mixed resin first outer layer included 88.5 wt % Admer® QF500A and 4.0 wt % Biomax® 120 as well as the same amount of EP copolymer Total 8473 and anti-blocking agents Tospearl® 120 and 130. The laminate film was measured for lamination bond, COF, optical properties, MVTR barrier, H bond adhesion strength, and abrasion resistance in accordance with the standard procedures described in the section of Test Methods.

### Example 6

A process similar to Example 1 was repeated except that the mixed resin first outer layer included a blend of 87.5 wt % Admer® QF 500A, 2.0 wt % Biomax® 120 and 3.0 wt % Lotader® 3210 as well as the same amount of EP copolymer Total 8473 and anti-blocking agents Tospearl® 120 and 130. The laminate film was measured for lamination bond, COF, optical properties, MVTR barrier, and H bond adhesion strength in accordance with the standard procedures described in the section of Test Methods.

### Example 7

A process similar to Example 1 was repeated except that the mixed resin first outer layer included a blend of 82.5 wt % Total 3374HA (aka EOD0437) and 10.0 wt % Lotader® 3210 and as well as the same amount of EP copolymer Total 8473 and anti-blocking agents Tospearl® 120 and 130. The laminate film was measured for lamination bond, COF, hot slip COF, optical properties, MVTR barrier, H bond adhesion strength, and abrasion resistance in accordance with the standard procedures described in the section of Test Methods.

### Example 8

A process similar to Example 1 was repeated except that the mixed resin first outer layer included 79.95 wt % Total 8473 and 20.0 wt % Lotader® 3210 as well as 0.05 wt % SILTON® JC-30. The laminate film was measured for lamination bond, COF, hot slip COF, optical properties, MVTR barrier, H bond adhesion strength, and abrasion resistance in accordance with the standard procedures described in the section of Test Methods.

### Example 9

A process similar to Example 1 was repeated except that the mixed resin first outer layer included 89.95 wt % Total 8473 and 10.0 wt % Arkema Lotader® 3210 as well as 0.05 wt % SILTON® JC-30. The laminate film was measured for lamination bond, COF, optical properties, MVTR barrier, and H bond adhesion strength in accordance with the standard procedures described in the section of Test Methods.

### Example 10

A process similar to Example 1 was repeated except that the mixed resin first outer layer included 89.45 wt % Total 8473, 10.0 wt % Arkema Lotader® 3210, and 0.05 wt % SILTON® JC-30 as well as 0.5 wt % Dow Corning MB50-801. The laminate film was measured for lamination bond, COF, optical properties, MVTR barrier, and H bond adhesion strength in accordance with the standard procedures described in the section of Test Methods.

### Example 11

A process similar to Example 1 was repeated except that the mixed resin first outer layer included 10.55 wt % Total 8473, 10.0 wt % Arkema Lotader® 3210, 78.4% Total 3374HA (aka EOD0437), 0.05 wt % SILTON® JC-30 as well as 1.0 wt % Dow Corning MB50-801. The laminate film was measured for lamination bond, COF, optical properties, MVTR barrier, and H bond adhesion strength in accordance with the standard procedures described in the section of Test Methods.

### Comparative Example 1

A process similar to Example 1 was repeated except that the mixed tie resin first outer layer resin included 100 wt % of Total 3374HA (aka EOD0437) resin. The laminate film was measured for lamination bond, COF, optical properties, MVTR barrier, and H bond adhesion strength in accordance with the standard procedures described in the section of Test Methods.

The physical properties of the Examples are shown in Table 2.

TABLE 2

| | Lam. Bond | COF (film/film) | | COF (film/platen) | | Haze | Gloss | | MVTR | H bond |
|---|---|---|---|---|---|---|---|---|---|---|
| Example # | (g/in) | μs | μd | μs | μd | (%) | 60° | 20° | (g/100 in²/day) | strength |
| Exam. 1 | 530 | 0.26 | 0.20 | 0.20 | 0.20 | 5.5 | 115 | 80 | 0.27 | 5 |
| Exam. 2 | 410 | 0.23 | 0.17 | 0.31 | 0.35 | 5.7 | 112 | 79 | 0.35 | 5 |
| CExam. 2 | 463 | 0.28 | 0.19 | 0.25 | 0.27 | 4.0 | 129 | 96 | 0.24 | 4 |
| Exam. 3 | 445 | 0.27 | 0.19 | 0.20 | 0.21 | 5.4 | 114 | 85 | 0.24 | 5 |
| Exam. 4 | 446 | 0.25 | 0.18 | 0.20 | 0.20 | 5.5 | 117 | 83 | 0.35 | 5 |
| Exam. 5 | 490 | 0.29 | 0.20 | 0.23 | 0.23 | 5.0 | 120 | 85 | 0.28 | 5 |
| Exam. 6 | 418 | 0.31 | 0.23 | 0.23 | 0.23 | 5.7 | 110 | 77 | 0.26 | 5 |
| Exam. 7 | 513 | 0.25 | 0.18 | 0.20 | 0.21 | 3.7 | 130 | 108 | 0.22 | 5 |
| Exam. 8 | 639 | 0.63 | 0.57 | 0.62 | 0.67 | 5.5 | 108 | 62 | 0.26 | 5 |
| Exam. 9 | 795 | 0.62 | 0.51 | 0.43 | 0.34 | 4.2 | 118 | 74 | 0.34 | 5 |
| Exam. 10 | 186 | 0.54 | 0.45 | 0.42 | 0.34 | 4.7 | 116 | 72 | 0.37 | 5 |
| Exam. 11 | 229 | 0.45 | 0.41 | 0.43 | 0.33 | 4.5 | 114 | 71 | 0.30 | 5 |
| CExam. 1 | 69 | 0.58 | 0.46 | 0.32 | 0.31 | 5.1 | 120 | 66 | 0.26 | 5 |

Lamination bond strength was tested in accordance with the Test Method described below. The failure mode observed for all samples is the same and lamination failed at the interface between the hot melt adhesive and tie layer of the laminate films. There were no failures observed at the interface bond between cardboard and hot melt adhesive or in the hot melt adhesive phase. A minimum bond strength of 400 g/in is needed for cardboard box lamination based on the customer request of this kind of application. The laminate films of Exam. 1 to 9 showed acceptable lamination bond strength to cardboard substrate after hot melt adhesive lamination. Exam. 1 and 7 showed lamination bond strength above 500 g/in. Exam. 10 and 11 containing Dow Corning MB50-801 demonstrated bond strength lower than 230 g/in which is significantly lower than the minimum needed bond strength to the cardboard substrate. Dow Corning MB50-801 masterbatch is a pelletized formulation containing 50 wt % of an ultra-high molecular weight siloxane polymer dispersed in polypropylene (PP) homopolymer. Without being bound by any theory, there probably exists residual silicone oil (low molecular weight) in the ultra-high molecular siloxane polymer. The silicone oil contaminated the tie layer blend and the lamination bond strength was reduced to an unacceptable level below 400 g/in. The tie-layer blends in Exam. 8 and 9 including EP copolymer Total 8473 and ethylene polar terpolymer Arkema Lotader® 3210 significantly improved the lamination bond strength to the cardboard substrate (639 to 795 g/in) when compared to Exam. 1 to 6 (410 to 530 g/in) wherein maleic anhydride-graft PP Admer® QF 500A, Lotader® 3210 and Biomax® 120 were used. The lamination bond strength of Exam. 7 with only 10% Lotader® 3210 polar ethylene terpolymer was at least equivalent to that of Exam. 1 to 6 wherein maleic anhydride grafted polyolefin was used. It is desirable that destructive paper fiber tear is observed and removed from cardboard substrate in lamination bond test. The lamination bond strength in Exam. 8 and 9 outperformed that of Exam. 1 to 7 probably due to the softness of Total 8473 EP copolymer which provided good mixing effects to hot melt adhesive lamination. As a comparison, Comparative Exam. 1 including only mini-random polypropylene showed extremely low lamination bond strength (69 g/in), which was undesirable and unacceptable for hot melt adhesive lamination to cardboard cartons.

The first outer layer of the film may include anti-blocking agents (ABA) to avoid film blocking and control the coefficient of friction (COF) of the film. The effective amount of ABA greatly depended upon the application of the oriented film. A combination of different slip agents or ABA agents in general was used to obtain lower COF effect for a film substrate. Before coextrusion, 5 wt % masterbatch was made by concentrating anti-blocking agents into ethylene-propylene copolymer carrier resin such as Total 8473. The static and dynamic COF of film against film (film/film) and film against stainless steel platen (film/platen), wherein the term “film” is defined as the top surface of the first outer layer of the multilayer OPP film, were tested at ambient temperature, respectively. In Exam. 1 to 7, cross-linked silicone particles, 1000 ppm Tospearl® 120 and 2500 ppm Tospearl® 130 were used to achieve lower COF effect. The static COF of the films in the examples was in the range of 0.23 to 0.31 while the dynamic COF was in the range of 0.17 to 0.23. The static COF by film/film test mode was slightly higher than that of film/platen while the dynamic COF of film/platen was slightly higher than that of film/film test mode. In two embodiments of Exam. 8 and 9, wherein 500 ppm Silton® JC-30 was incorporated into the first outer layer, both static COF and dynamic COF of the films were much higher than that observed for Exam. 1 to 7 as shown in Table 2. In Exam. 10 and 11, a silicone gum, ultra high molecular weight polydimethyl siloxane MB50-801, was incorporated into the first outer layer at a content of 0.5 and 1.0 wt %, respectively. Compared to the COF of Exam. 9, both static and dynamic COF obtained from film/film test method slightly decreased with increasing silicone gum loading. There was no change in the COF values of film/platen test mode. It is noted that the COF value of film/film-mode in Exam. 9 to 11 was higher than the COF value of film/platen-mode, compared to Exam. 8 in which the first outer layer included 20 wt % Lotader® 3210 ethylene copolymerized polar terpolymer and 79.95 wt % Total 8473 ethylene-propylene copolymer as well as 500 ppm Silton® JC-30. A laminate film with high film/platen COF is not feasible for high speed production of cardboard laminate boxes and scuffing and scratching of the film surface may occur due to high COF.

According to the COF values listed in Table 2, Exam. 2, 4 and 7 showed COF values close to the preferred COF values (static 0.25 and dynamic 0.20) for cardboard lamination. ABA particle size, ABA loading, distribution, and film surface hardness were factors that influenced the COF values of the laminates. COF values changed with increasing temperature (also known as “hot slip” COF) as showed in Table 3. The COFs of Exam. 1, 7, and 8 (first outer layer/platen) increased slightly with increasing temperature. Only Exam. 2 showed slight decrease in COF value with increasing temperature. Exam. 8 showed extremely high COF values at both ambient and elevated temperatures that were undesirable for cardboard hot melt adhesive lamination.

TABLE 3
Hot slip COF of laminate films

| Hot slip COF (the first outer layer/platen) | | |
|---|---|---|
| Ambient | 40° C. | 60° C. |

| Example # | μs | μd | μs | μd | μs | μd |
|---|---|---|---|---|---|---|
| Exam. 1 | 0.20 | 0.20 | 0.28 | 0.26 | 0.25 | 0.24 |
| Exam. 2 | 0.35 | 0.31 | 0.29 | 0.27 | 0.27 | 0.26 |
| Exam. 7 | 0.20 | 0.21 | 0.30 | 0.28 | 0.30 | 0.28 |
| Exam. 8 | 0.63 | 0.57 | 0.74 | 0.72 | 0.75 | 0.78 |

High clarity and low haze were basic optical properties for the laminate film to provide aesthetic appearance in packaging. The haze was preferably less than 4.5% and the gloss (60°) was preferably higher than 120. Only two laminate films (CExam. 2 and Exam. 7) met the request in all examples. CExam. 2 was a laminate film coated with polyurethane at about 0.3 μm to 0.4 μm thick. The tie resin first outer layer of CExam. 2 included 90 wt % Admer® QF 500A, 2.5 wt % Lotader® 3210, and 7.15 wt % of Total 8473 EP copolymer, as well as ABA particles. The optical properties of CExam. 2 were improved significantly through inline coating process, compared to that of Exam. 2. Exam. 7 was the only coextruded laminate film which had good optical properties fit for use in the application discussed. The tie layer of Exam. 7 included 82.5 wt % mini-random polypropylene, 10 wt % Lotader 3210, and 7.15 wt % Total 8437 as well as ABA particles.

The moisture barrier of the laminate films in the examples was below the target maximum request of 0.5 g/100 in²/day, suggesting that biaxially oriented polypropylene provided excellent moisture barrier property to a packaged product.

H bond strength is defined as the bond strength between the tie layer and the core layer of the laminate film. The H bond strength of all examples except for CExam. 2 showed perfect adhesion (rank#=5 “best”) between the tie layer and the core layer of the laminate as shown in Table 2. Tie layer resins used in the examples have good molecular similarity and compatibility to the core layer of the laminate film. If the adhesion is poor, the tie layer as a whole can be separated from the core of the laminate. CExam. 2 showed excellent adhesion (rank#=4) because some materials on the top surface was removed in the test; however, the materials are probably coating debris. Therefore the tie layer still has perfect adhesion to the core of the laminate as that observed for Exam. 2.

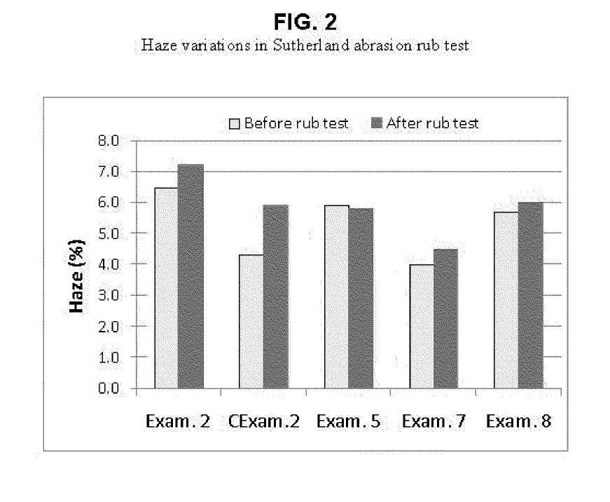

The abrasion resistance of laminate films for Exam. 2, CExam. 2, Exam. 5, Exam. 7 and Exam. 8 are shown in FIG. 2, which illustrates the variation of the haze of a coextruded laminate film before and after a Sutherland rub test (abrasion resistance test).

The results illustrated that the blends of ethylene-propylene copolymer and ethylene polar terpolymer provided good adhesion between hot melt adhesive and polypropylene biaxially oriented films as well as good processability. The adhesion strength provided by these tie-layer formulations was similar to that of anhydride-grafted polyolefin. Thus, this new family of resin blends can be used as tie-layers between polar materials like EVOH and polyolefin materials like polypropylene.

### Test Methods

The laminate film properties of the examples discussed above were measured by the following methods:

Melting point of a resin or polymer blend was measured using a differential scanning calorimeter (DSC) Q1000 made by TA Instruments and was determined substantially in accordance with ASTM D3417-99.

Melt flow rate of a resin or polymer blend was measured using Extrusion Plastomer made by Tinius Olsen in accordance with ASTM D1238 at conditions of 230° C. and 2.16 kg weight.

The haze of a film was measured using Gardner Hazegard Plus made by BYK in accordance with ASTM D 1003.

The gloss of a film was measured using glossmeter micro-gloss made by BYK in accordance with ASTM 523.

The coefficient of friction (COF) of the surface of a film was measured using Monitor/Slip & Friction Model No. 32-06 made by Testing Machines Inc. in accordance with ASTM D1894-11E. Hot slip (film against stainless steel) COF was tested using the same equipment at elevated temperatures of 40 and 60° C.

Sutherland abrasion test was conducted on Sutherland Rub Tester with a 2 lb weight, face to face, and twenty replicate rubs were performed on one sheet sample. Three specimens were collected across the sheet sample after testing, haze of the specimens was measured using Gardner Hazegard Plus and compared to that before testing.

Moisture vapor transmission rate (MVTR) of the clear BOPP film was measured using a Mocon Permatran (Model 3/31) at conditions of 100° F./90% RH (38° C./90% RH) in accordance with ASTM F1249. A MVTR value of clear BOPP film with desirable moisture protection to cardboard boxes is ≦0.50 g/100 in²/day.

H bond strength is defined as the adhesion of the polar skin (tie layer) to the core layer BOPP film. It was measured using a 3M 1-inch wide 610 H tape. The tape was completely adhered to the polar skin surface (i.e. first outer layer) of a single sheet of film and then removed quickly from the surface. The adhesion of the polar skin (tie layer) to the core layer of BOPP film was rated qualitatively as follows:
5=Perfect=0% polar skin removed
4=Excellent=1-10% polar skin removed
3=Good=11-30% polar skin removed.
2=Fair=31-50% metal removed
1=Poor=>50% polar skin removed

In general, preferred values were Excellent to Good (4-3) for coating and inks The numerical rating range was estimated from visual observations on the cracked materials transferred from BOPP polar skin layer to H tape after testing.

Preparation of laminated cardboard specimens: the H.B Fuller HM-2835-Y hot melt adhesive (Tₘ=150° F. or ca. 65.5° C.) was placed in a beaker on a hot plate and was heated to 220° F. (ca. 104° C.) and then spread into a thin layer onto cardboard using a spatula. After the hot melt adhesive cooled and solidified, the tie layer side (i.e. first outer layer) of a test BOPP film along the MD direction was laid on over the hot melt adhesive. This construction was run through a hot nip set at 220° F. (or ca. 104° C.) of a ChemInstruments, Inc. Hot Roll Laminator Model HL-100, set at a nip pressure of 80 psi (ca. 55.16 N/cm²) and speed mark “1” to form a cardboard laminate structure. Laminate specimens were cured a minimum of 24 hrs before lamination bond strength test.

Laminate bond strength between cardboard and BOPP film was measured using an Instron Tensile Tester (Model 4201). Three different samples of a laminate were prepared into 1 inch wide (2.54 cm) strip specimens for testing. The bond strength was evaluated in a 90° T-peel mode test as described by ASTM D1876.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A laminate film structure comprising:
a core layer comprises at least 50 wt % polyolefin;
a first outer layer comprising a blend of a modified polar polyolefin and ethylene-propylene copolymer or mini-random polypropylene;
a cardboard or paper layer; and
a hot melt adhesive layer to adhere the first outer layer to the cardboard or paper layer.

2. The laminate film structure of claim 1, further comprising a second outer layer comprising mini-random polypropylene and ethylene-propylene copolymer.

3. The laminate structure of claim 1, wherein the modified polar polyolefin is maleic anhydride grafted polyolefins.

4. The laminate film structure of claim 1, wherein the modified polar polyolefin is an ethylene copolymerized polar polymer.

5. The laminate film structure of claim 1, wherein the first outer layer comprises modified polar polyolefin, ethylene-propylene copolymer, and mini-random polypropylene.

6. The laminate film structure of claim 1, wherein the first outer layer comprises an ethylene-propylene copolymer with an ethylene content of from of 0.5 wt % to 15 wt %.

7. The laminate film structure of claim 1, wherein the first outer layer comprises a mini-random polypropylene with an ethylene content of 1.0 wt % or less.

8. The laminate film structure of claim 1, wherein the first out layer comprises an anti-blocking agent and a processing aid.

9. The laminate film structure of claim 8, wherein the anti-blocking agent is selected from silicas, SiO₂, CaO₃, sodium calcium aluminosilicates, cross-linked silicone polymers, cyclic olefin copolymer, polymethylmethacrylate (PMMA) spheres, and ultra-high molecular weight polydimethyl siloxane (PDMS).

10. The laminate film structure of claim 8, wherein the anti-blocking agent comprises 0.03 wt % to 5 wt % of the first outer layer.

11. The laminate film structure of claim 8, wherein the anti-blocking agent has a mean particle size of 2 to 6 μm.

12. The laminate film structure of claim 8, wherein the processing aid is a fluoropolymer.

13. The laminate film structure of claim 8, wherein the active content of processing aid is less than 1000 ppm.

14. The laminate film structure of claim 2, wherein the first out layer and the second outer layer comprise an anti-blocking agent and a processing aid.

15. The laminate film structure of claim 1, wherein the core layer comprises 80 wt % to 100 wt % propylene homopolymer and 20 wt % or less of a modifier.

16. The laminate film structure of claim 15, wherein the core layer comprises a hydrocarbon resin, a copolymer or a terpolymer modifier.

17. The laminate film structure of claim 1, wherein the first outer layer is discharged treated.

18. A laminate film structure comprising:
a core layer comprises at least 50 wt % polyolefin;
a first outer layer comprising maleic anhydride-grafted polyolefins, ethylene copolymerized polar polymers, ethylene-propylene copolymers and mini-random polypropylene;
a cardboard or paper layer; and
a hot melt adhesive layer to adhere the first outer layer to the cardboard or paper layer.

19. The laminate film structure of claim 18, wherein the first outer layer comprises 1 wt % to 95 wt % maleic anhydride grafted polyolefins.

20. The laminate film structure of claim 18, wherein the first outer layer comprises 1 wt % to 20 wt % ethylene copolymerized polar polymers.

21. The laminate film structure of claim 18, wherein the first outer layer comprises 5 wt % to 30 wt % ethylene-propylene copolymers.

22. The laminate film structure of claim 18, wherein the first outer layer comprises 1 wt % to 85 wt % mini-random polypropylene.

23. The laminate film structure of claim 18, wherein the maleic anhydride-grafted polyolefins are homopolymers, copolymers and terpolymers comprising monomers of propylene, ethylene, and butylene.

24. The laminate film structure of claim 18, wherein the maleic anhydride-grafted polyolefins are produce by grafting a maximum of 1.0 wt % of maleic anhydride onto polyolefins.

25. The laminate film structure of claim 18, wherein the ethylene copolymerized polar polymers are copolymers or terpolymers comprising ethylene and at least one polar co-monomer.

26. The laminate film structure of claim 18, wherein the ethylene content of the ethylene copolymerized polar polymers is from 80 wt % to 95 wt %.

27. The laminate film structure of claim 18, wherein the ethylene copolymerized polar polymers comprise maleic anhydride, carboxylic acids, esters of maleic anhydride or carboxylic acids.

28. The laminate film structure of claim 18, wherein the ethylene copolymerized polar polymers comprise maleic anhydride and at least one other polar co-monomer.

29. The laminate film structure of claim 28, wherein a total polar co-monomer content in the ethylene copolymerized polar polymers is 5 wt % to 30 wt %.

30. The laminate film structure of claim 18, wherein the first outer layer comprises an ethylene-propylene copolymer with an ethylene content of from of 0.5 wt % to 15 wt %.

31. The laminate film structure of claim 18, wherein the first outer layer comprises a mini-random polypropylene with an ethylene content of 1.0 wt % or less.

32. The laminate film structure of claim 18, wherein the first out layer comprises an anti-blocking agent and a processing aid.

33. A method of making a laminate film structure comprising:
co-extruding a film comprising a core layer comprises at least 50 wt % polyolefin and a first outer layer comprising a blend of a modified polar polyolefin and ethylene-propylene copolymer or mini-random polypropylene; and
bonding a cardboard or paper layer to the film using a hot melt adhesive.

34. The method of claim 33, wherein the film is biaxially oriented.

35. The method of claim 33, further comprising co-extruding a second outer layer comprising mini-random polypropylene and ethylene-propylene copolymer with the core layer and the first skin layer.
